(19) United States
(12) Patent Application Publication
(10) Pub. No.: US 2004/0192134 A1
(43) Pub. Date: Sep. 30, 2004

(54) Flame-resistant and high visibility fabric and apparel formed therefrom

(76) Inventors: Richard M. Gibson, Weaverville, NC (US); Willis D. Combbell JR., Summerfield, NC (US); Albert E. Johnson, Burlington, NC (US); Kenneth P. Wallace, Burlington, NC (US); Allen J. Hawks, Mebane, NC (US)

Correspondence Address: C. Robert Rhodes, Esq., Womble Carlyle Sandridge & Rice PLLC, P. O. Box 7037, Atlanta, GA, 30357-0037, US

(21) Appl. No.: 10/701,714

(22) Filed: Nov. 5, 2003

Related U.S. Application Data
(63) Continuation-in-part of application No. 09/851,888, filed on May 9, 2001, now Pat. No. 6,706,650.

(51) Int. Cl. B32B 27/04; D06L 3/12; B32B 5/02; B32B 27/12; B32B 27/20; B05B 5/00; B32B 27/02; B27N 9/00

(52) U.S. Cl. 442/167; 442/130; 442/164; 428/920; 428/921; 427/157

(57) ABSTRACT

A fabric for use in safety apparel comprising yarns spun from a blend of staple fibers. At least 60 percent of the staple fibers are flame resistant fibers and up to 40 percent are non-flame resistant fibers. At least one dye type is applied to the fabric and is selected to dye both the flame resistant and non-flame resistant fibers in the blend. When dyed, the fabric meets both the American National Standards Institute standard ANSI/ISEA-107 minimum conspicuity requirements for occupational activities for high-visibility safety apparel and the American Society for Testing and Materials standard ASTM F-1506 for flame resistance.

### RELATED APPLICATIONS

This is a continuation-in-part of application Ser. No. 09/851,888, filed May 9, 2001, the content of which is hereby incorporated in its entirety.

### FIELD OF THE INVENTION

The present invention relates generally to fabric and safety apparel formed therefrom, and more particularly to fabric and apparel that meets nationally-recognized standards for flame-resistance and high-visibility.

### BACKGROUND OF THE INVENTION

Authorities worldwide have recognized the need to protect occupational workers from the inherent hazards of apparel that is deficient in contrast and visibility when worn by workers exposed to the hazards of low visibility. These hazards are further intensified by the often complex backgrounds found in many occupations such as traffic control, construction, equipment operation, and roadway maintenance. Of major concern is ensuring that these workers are recognized by motor vehicle drivers in sufficient time for the drivers to slow-down or take other preventive action to avoid hazard or injury to the workers. Thus, worker safety is jeopardized when clothing not designed to provide visual identification is worn by persons working in such dangerous environments.

While there are no federal regulations governing the design, performance, or use of high-visibility apparel, local jurisdictions and private entities have undertaken to equip their employees with highly luminescent vests. One national standards organization, known as the American National Standards Institute (ANSI), in conjunction with the Safety Equipment Association (ISEA), has developed a standard and guidelines for high-visibility luminescent safety apparel based on classes of apparel.

Similarly, and in related fashion, certain of the above-mentioned occupations also require safety apparel that is flame resistant. For example, electric utility workers who may be exposed to flammable conditions require apparel that is flame resistant. In the United States, there is a nationally-recognized standard providing a performance specification for flame resistant textile materials for safety apparel, referred to as the American Society for Testing and Materials (ASTM), standard F 1506. This standard provides performance properties for textile materials used in apparel that represent minimum requirements for worker protection. One component of this standard is the vertical flame test which measures whether an apparel will melt or drip when subjected to a flame, or continue to bum after the flame is removed.

Recently, it was found that safety apparel could be produced to meet both of these nationally-recognized standards; however, the fabric heretofore used in the construction of safety apparel has been formed entirely from flame resistant yarns such as modacrylics.

### SUMMARY OF THE INVENTION

The present invention is directed to a fabric, and apparel formed therefrom, that meets both of these nationally-recognized standards, yet does not have to be formed from 100% flame resistant yarns. It has now been found that fabric formed from yarns that are a blend of flame resistant and certain conventional staple fiber materials will also meet both of these standards. More particularly, because the flame resistant and conventional staple fibers are uniformly distributed throughout the spun yarn, the resulting fabric provides better flame resistance and higher visibility than would a core spun yarn and fabric having a flame resistant component and conventional outer wraps.

ANSI/ISEA-107-1999 specifies requirements for apparel capable of signaling the wearer's presence visually and is intended to provide conspicuity of the wearer in hazardous situations under any light conditions by day and under illumination by vehicle headlights in the dark. As used herein, and as defined in ANSI/ISEA-107, “conspicuity” refers to the characteristics of an object which determine the likelihood that it will come to the attention of an observer, especially in a complex environment which has competing foreground and background objects. Conspicuity is enhanced by high contrast between the clothing and the background against which it is seen. The ANSI standard specifies performance requirements for color, luminance, and reflective area. Three different colors for background and combined performance are defined in the standard. The color selected should provide the maximum contrast with the anticipated background for use of the apparel. Several combinations are described in the standard depending upon the intended use. For example, the ANSI standard also describes three classes of conspicuity. For utility workers, the apparel would meet either Class 2 or Class 3 (Appendix B of ANSI 107-1999).

ASTM F 1506 provides a performance specification that may be used to evaluate the properties of fabrics or materials in response to heat and flame under controlled laboratory conditions. The properties of materials for basic protection level wearing apparel should conform to the minimum requirements for woven or knitted fabrics with respect to breaking load, tear resistance, seam slippage, colorfastness, and flammability before and after laundering. ASTM F 1506 specifies these performance characteristics based on fabric weight ranges, expressed in ounces per square yard. While ASTM F 1506 specifies minimum acceptance criteria in several categories, simply stated, the fabric and apparel will not melt or drip when subjected to a vertical flame burn test. Further, apparel meeting the acceptance criteria of this standard will not continue to burn after exposure to and removal from a source of ignition.

The rigorous performance specifications of both of the above standards are met by the fabric and safety apparel of the present invention. One aspect of the present invention is directed to fabric formed from a blend of staple fibers that comprise at least about 60% flame resistant fibers, such as modacrylic staples. Alternatively, other flame resistant fibers such as the aramids may be substituted for, or combined with, the modacrylic fibers. The remaining, non-flame resistant, staple fibers are selected from more conventional synthetic polymer or natural fiber material. Specifically, it has been found that polyester, nylon, rayon, cotton, and wool are particularly suited for blending with the modacrylic or aramid fibers. As is well known in the art, staples are defined as fibers having a length of less than about 2.5 inches. A blend is also well known in the art as the combination of two or more staple fibers, wherein when combined, the different staple fibers are uniformly distributed.

Modacrylic fibers, by definition, are composed of less than 85 percent, but at least 35 percent by weight of acrylonitrile units. Modacrylic fibers have two characteristics that address the problems confronted by the inventors of the present invention. First, modacrylic fibers are inherently flame resistant, with the level of flame resistance varying based upon the weight percentage of acrylonitriles in the composition. Secondly, modacrylic fibers are very receptive to cationic dyes, which are known for their brilliance. Aramid fibers exhibit low flammability, high strength, a high modulus, and maintain their integrity at high temperatures.

Polyester fibers have high strength and are resistant to shrinking and stretching. Other non-flame resistant fibers include nylon, rayon, cotton, and wool. Nylon fibers also have high strength, toughness, and abrasion resistance. Rayon is composed of regenerated cellulose and can be formed into high strength fibers having a good hand and good aesthetic characteristics. Cotton is also strong and has excellent absorbency. Wool, on the other hand, blends well with both synthetic and other natural fibers to form a blend having good tensile strength. While polyester, nylon, rayon, cotton, and wool are economical constituents of the blend that have been found particularly suitable for blending with modacrylic staples, other synthetic polymers may also be suitably blended with the modacrylic or aramidic staples. The choice of one or more staple fibers to blend with the flame resistant staples depends upon other non-flame resistant properties desired in the finished fabric and apparel, including hairiness and hand, strength, flexibility, absorbency, etc.

In an exemplary embodiment, fabric constructed according to the present invention is spun in accordance with conventionally known techniques. To form yarns from the blend of fibers, following the opening, carding, and drawings of slivers, the slivers may be ring spun, open end spun, air jet spun, etc.

The fabric may be either woven or knit. With fabric formed from blended yarns, a two-step dyeing process is typically used. The inherently flame resistant material is dyed in conventional fashion in a jet dye machine with cationic, or basic, dyestuff compositions to obtain International Yellow or International Orange hues that will meet the luminescence and chromacity requirements of ANSI/ISEA-107-1999. While basic, or cationic, dyes are known for their acceptability on modacrylics, it has been heretofore unknown to apply such dyestuffs in the international colors to flame-resistant modacrylics to obtain shades and luminescence satisfactory for safety apparel. Where the flame resistant material is an aramid, cationic dyes may also be used to achieve the desired level of luminescence and chromacity. The choice of which other synthetic or natural fiber is blended with the flame resistant fiber will determine the type of dye needed to achieve the desired luminescence and chromacity of the finished fabric, as discussed in detail below.

These and other aspects of the present invention will become apparent to those skilled in the art after a reading of the following description of the preferred embodiment.

### DESCRIPTION OF THE PREFERRED EMBODIMENT

Having described the industry standards that provide the acceptance criteria for basic protection levels for occupational workers, the fabric, and apparel formed therefrom, of the present invention are formed from yarn that is a blend of materials that will meet each of the standards.

In one preferred embodiment, the fabric is formed from yarns that are spun from a blend of staple fibers, wherein at least 60 percent of the staple fibers are flame resistant fibers. One suitable flame resistant fiber is modacrylic fiber, although other flame resistant acrylics and flame resistant synthetic polymers may be substituted therefor. In this preferred embodiment, the modacrylic fibers comprise at least about 60 percent of the total fibers. Alternatively, in another embodiment, aramidic fibers my be either substituted for, or combined with, modacrylic fibers.

The modacrylic staple fibers are blended with other more conventional fibers. For example, the modacrylic staples may be blended with up to 40 percent of other synthetic or natural fibers. Examples of synthetic fibers that have been found particularly suitable include polyester, rayon, and nylon. Alternatively, the modacrylic staples may be blended with up to 40 percent natural fibers, such as cotton and wool.

Modacrylics are polymers that have between 35 percent and 85 percent acrylonitrile units, modified by other chemical modifiers such as vinyl chloride. All modacrylics have a flame-resistant character to some extent, however, it has been found that fabrics formed from modacrylic yarns having at least about 50 percent by weight of acrylonitrile units will provide excellent flame resistance. That is, they will not melt and drip, or continue to burn when a source of ignition is removed. Although other modacrylic fibers could be used to form the yarn and fabric of the present invention, the yarn and fabric of the present invention is formed from staple fibers of Kanecaron® SYS. Kanecaron® SYS is a 1.7 denier, 2 inch modacrylic staple fiber manufactured by Kaneka Corporation, Osaka, Japan. Kanecaron® SYS fiber has a tenacity of about 3 grams/denier, a Young's Modulus of about 270 kg/mm², a dull luster, and has been found to meet the structural requirements of both ANSI/ISEA-107-1999 and ASTM F 1506. Modacrylic fibers having tenacities of at least about 2 grams/denier are also suitable to form the yarn and fabric of the present invention.

Aramid fibers are also manufactured fibers in which the fiber-forming material is a long chain synthetic polyamide having at least 85 percent of its amide linkages attached directly to two aromatic rings. These fibers exhibit low flammability, high strength, high modulus, and also maintain their integrity at high temperatures.

Polyester fibers have high strength and are resistant to shrinking and stretching. Nylon fibers also have high strength, toughness, and abrasion resistance. Rayon is composed of regenerated cellulose and can be formed into high strength fibers having a good hand and good aesthetic characteristics. Cotton is also strong and has excellent absorbency. Wool, on the other hand, blends well with both synthetic and other natural fibers to form a blend having good tensile strength. While polyester, nylon, rayon, cotton, and wool are economical constituents of the blend that have been found particularly suitable for blending with modacrylic staples, other synthetic polymers may also be suitably blended with the modacrylic staples. The choice of one or more staple fibers to blend with the modacrylic staples depends upon other non-flame resistant properties desired in the finished fabric and apparel, including hairiness and hand, strength, flexibility, absorbency, etc.

### THE PROCESS

As is conventional in staple yarn manufacture, bales of staple fibers, in the percentages described above, are initially subjected to an opening process whereby the compacted fibers are “pulled” or “plucked” in preparation for carding. Opening serves to promote cleaning, and intimate blending of fibers in a uniform mixture, during the yarn formation process. Those skilled in the art will appreciate that there are a number of conventional hoppers and fine openers that are acceptable for this process. The open and blended fibers are next carded using Marzoli CX300 Cards to form card slivers. The card slivers are transformed into drawing slivers through a drawing process utilizing a process known as breaker drawing on a Rieter SB951 Drawframe and finisher drawing on a Rieter RSB951 Drawframe. Drawn slivers are next subjected to a Roving process conventionally known in preparation for Ring Spinning. A Saco-Lowell Rovematic Roving Frame with Suessen Drafting is used to twist, lay and wind the sliver into roving. A Marzoli NSF2/L Spinning Frame is used to ring spun the yarn product. Winding, doubling, and twisting processes conventionally known in the art are used in completing the yarn product. A finished yarn found structurally suitable for the present invention is an 18 singles, 2-ply construction.

The illustrated fabric is woven; however, other constructions, such as knitted, and non-woven constructions may be used, provided they meet the design and structural requirements of the two standards. The exemplary fabric is woven (plain weave) on a Picanol air jet loom with 46 warp ends and 34 fill ends of yarn per inch and an off-loom width of 71 inches. Any looms capable of weaving blended yarns may just as suitably be used. The woven fabric has a desired weight of approximately 4 to 20 ounces per square yard, and desirably about 7.5 ounces per square yard as necessary to satisfy the design requirements for the particular class of safety apparel.

In preparation for dyeing, the woven fabric is subjected to desizing and scouring to remove impurities and sizes such as polyacrylic acid. The process of desizing is well known in the art. A non-ionic agent is applied in a bath at between about 0.2 and 0.5 weight percent of the fabric and an oxidation desizing agent is applied in a bath at about 2 to 3 percent of fabric weight. The use of such agents is well known in the art. The processing, or run, time for desizing and scouring is approximately 15 to 20 minutes at 60° C. The fabric is then rinsed with water at a temperature of 60° C.

The pretreated fabric is then ready for dyeing and finishing. It is well known to those in the art that the dyeing of fabric formed from blended yarns will normally require multiple dyestuffs. Because of the combination of different dyes and their individual temperature and processing requirements, dyeing is typically a two-step process. The dyeing is formed in a jet dye machine such as a Model Mark IV manufactured by Gaston County Machine Company of Stanley, N.C. The specific dyes used to color the modacrylic component of the present invention are basic, or cationic, dyestuffs. The cationic dyes are known for their acceptability in dyeing polyesters, nylons, acrylics, and modacrylics. Until recently, it was not known that these dyes could be formulated to dye modacrylic material in order to meet the luminance and chromacity criteria for safety apparel according to ANSI/ISEA-107 and the fire resistant criteria of ASTM F 1506. Two dye formulations have been found to meet the high visibility criteria for ANSI/ISEA-107. A dye formulation for International Yellow comprises basic Flavine Yellow, available from Dundee Color of Shelby, N.C. as color number 10GFF. It has been found that this dyestuff applied at between about 2 to 2½ percent of fabric weight successfully achieves the ANSI criteria. A dye formulation for International Orange may be formed from Blue and Red cationic dyestuffs, available from Yorkshire America in Rock Hill, S.C., as color numbers Sevron Blue 5GMF and Sevron Brilliant Red 4G and applied at percentages sufficient to meet the ANSI/ISEA-107 shade requirements.

For dyeing the modacrylic component of the fabric, a dyestuff, as described above is added to the jet dye machine. The Ph of the bath is established at between about 3 and 4, with acid used to adjust the Ph as required. The bath temperature in the jet dyer is raised at about 1° C. per minute to a temperature of about 80° C., where the temperature is held for approximately 10 minutes. The temperature is then raised approximately 0.50° C. per minute to a temperature of 98° C. and held for approximately 60 minutes. The bath is then cooled at about 2° C. per minute to 60° C. At that point, the bath is emptied and rinsing with water at 60° C. occurs until the dye stuff residue in the jet dyer is removed. Cationic dyestuffs are also preferred where the flame resistant material is an aramid.

For the second stage of the dyeing processs, a dyestuff is selected that is suitable for the selected component of the yarn, and hence the fabric. Where the second component is polyester, the preferred dye is a disperse dye having a color formulation that is comparable to the formulation used to dye the flame resistant component. As those skilled in the art will appreciate, the procedure and controls for applying the various types of dyes are well known and vary with the material being dyed. Where the second component is nylon, the preferred dye is an acid dye, again having a color formulation that is comparable to the formulation used to dye the flame resistant component. Where the second component is rayon, the preferred dyestuffs include direct dyes, reactive dyes, and vat dyes.

Where the second component is a natural material, such as cotton, the preferred dyestuffs include direct dyes, reactive dyes, and vat dyes. Where wool is the selected second component, the preferred dye is an acid dye.

At this point, the dyeing cycle is complete. Wet fabric is removed from the dye machine where it is dried on a standard propane open width tenter frame running at approximately 40 yards per minute at approximately 280° F. to stabilize width and shrinkage performance. At the completion of this process, the fabric meets the ANSI standard for high visibility safety apparel and the ASTM standard for flame resistance.

The finished fabric may be used to construct an unlimited number of types of safety apparel. The most common types are shirts or vests, and trousers or coveralls. The final constructed garments are designed and formed to meet the design, structural, and fastening criteria of the ANSI and ASTM standards.

Certain modifications and improvements will occur to those skilled in the art upon a reading of the foregoing description. It should be understood that all such modifications and improvements have been deleted herein for the sake of conciseness and readability but are properly within the scope of the following claims.

We claim:

1. A fabric for use in safety apparel, comprising:
(a) yarns spun from a blend of staple fibers, at least 60 percent of the staple fibers being flame resistant fibers and up to 40 percent non-flame resistant fibers;
(b) at least one dye type applied to said fabric that is selected to apply a high-visibility dye to both the flame resistant and non-flame resistant fibers in the blend; and
(c) wherein, the fabric meets both the American National Standards Institute standard ANSI/ISEA-107 minimum conspicuity requirements for occupational activities for high-visibility safety apparel and the American Society for Testing and Materials standard ASTM F-1506 for flame resistance.

2. The fabric of claim 1 wherein a majority of the flame resistant fibers are selected from the group consisting of modacrylic fibers and aramid fibers.

3. The fabric of claim 1 wherein the non-flame resistant fibers are selected from the group consisting of polyester, nylon, rayon, wool, and cotton.

4. The fabric of claim 1 wherein said fabric is woven.

5. The fabric of claim 2 wherein said flame resistant fibers have a tenacity of at least about 2 grams/denier.

6. The fabric of claim 1 wherein the spun yarns are selected from the group consisting of ring spun yarns, open end spun yarns, and air jet spun yarns.

7. The fabric of claim 1 where the flame resistant fibers are dyed with a cationic dye and the non-flame resistant fibers are dyed with a dye compatible therewith.

8. A safety garment having high visibility and flame resistant characteristics formed from:
(a) a fabric formed from yarns spun from a blend of staple fibers, at least 60 percent of the staple fibers being flame resistant fibers, and up to 40 percent non-flame resistant fibers;
(b) at least one dye type applied to said fabric that is selected to apply a high-visibility dye to both the flame resistant and non-flame resistant fibers in the blend; and
(c) wherein, the fabric meets both the American National Standards Institute standard ANSI/ISEA-107 minimum conspicuity requirements for occupational activities for high-visibility safety apparel and the American Society for Testing and Materials standard ASTM F-1506 for flame resistance.

9. The safety garment of claim 8 wherein a majority of the flame resistant fibers are selected from the group consisting of modacrylic fibers and aramid fibers.

10. The safety garment of claim 8 wherein the non-flame resistant fibers are selected from the group of fibers consisting of polyester, nylon, rayon, cotton, and wool.

11. The safety garment of claim 8 wherein said fabric is woven.

12. The safety garment of claim 9 wherein said flame resistant fibers have a tenacity of at least about 2 grams/denier.

13. The safety garment of claim 8 wherein the spun yarns are selected from the group consisting of ring spun yarns, open end spun yarns, and air jet spun yarns.

14. The safety garment of claim 8 wherein the flame resistant fibers are dyed with a cationic dye and the non-flame resistant fibers are dyed with a dye compatible therewith.
